(19) United States
(12) Patent Application Publication
(10) Pub. No.: US 2013/0282536 A1
(43) Pub. Date: Oct. 24, 2013

(54) SYSTEMS AND METHODS FOR MANAGING ELECTRONIC TICKET PASSES

(71) Applicants: Farzeen Mohazzabfar, Kirkland, WA (US); Mark Hotopp, Kirkland, WA (US)

(72) Inventors: Farzeen Mohazzabfar, Kirkland, WA (US); Mark Hotopp, Kirkland, WA (US)

(21) Appl. No.: 13/452,512

(22) Filed: Apr. 20, 2012

(51) Int. Cl. G06Q 40/00

(52) U.S. Cl. 705/30

(57) ABSTRACT

Techniques for managing electronic ticket passes are described. Some embodiments provide an electronic ticket pass system (“ETPS”). The ETPS provides an electronic ticket pass that enables entry by a customer to multiple venues selected by the customer. When a customer visits a venue, the ETPS validates the customer's electronic ticket pass and tracks their visit to the venue. Upon expiration of the ticket pass, the ETPS credits the venues visited by the customer based on the price of the electronic ticket pass, the individual admission price for each venue, and handling fees.

### FIELD OF THE INVENTION

The present disclosure relates to systems and methods for electronic ticket passes and, more particularly, to systems and methods for distributing, managing, and accounting for electronic ticket passes that facilitate entry into multiple different venues selected by a customer.

### BACKGROUND OF THE INVENTION

When tourists visit a city, they can commonly purchase a ticket book containing a group of tickets, which allows them access to a number of venues in the area for a set period of time. The benefit to the tourist is that they obtain access to the venues at a reduced cost. The benefit to the venues is that a larger number of tourists are able to visit sites that they normally could not afford to visit or would be disinclined to visit because of the cost.

The ticket book is a simple means for tourists to visit venues in a city. A tourist may purchase a ticket book for each member of his party at any of the venues throughout a city-typically those represented in the ticket book. Based on the purchase time, the tourist can use the tickets in the book throughout a period of time, generally about a week, before the tickets in the book expire. At each venue of their choosing, the tourist removes the ticket from the book and hands it to the ticket handler. The tourist can then enter and enjoy the venue. The ticket handler retains the ticket so that the venue can be reimbursed for the ticket from the servicer of the ticket pass booklet.

Although ticket books are simple to handle for the tourist, there are problems with this system. First, if a ticket book is lost or stolen, there may be no way for the tourist to get reimbursed or get the ticket book reissued. The tourist may simply lose the money. Second, accounting for the ticket books is a complex exercise. Each vendor selling the ticket books must purchase them from the ticket pass servicer. This cost remains on a given vendor's books until all ticket books are sold or are returned to the ticket pass servicer for a refund. Third, the vendor must keep track of the tickets that are used at their venue and return the physical tickets to the ticket pass servicer for reimbursement. Fourth, the tourist is limited in the number of options they get when purchasing a ticket pass. There is typically only one set of tickets in a book and if the tourist has no interest in some of the venues they must determine for themselves if the cost of the books is worth the value of the remaining tickets.

### SUMMARY OF THE INVENTION

In one aspect of the present invention, a system for managing electronic ticket passes includes a processor, a memory, and a module that is stored in the memory and that is configured, when executed by the processor, to provide an electronic ticket pass that facilitates entry by a customer to each venue of a first set of venues, track visits by the customer to venues of a second set of venues that is a subset of the first set of venues, and upon expiration of the electronic ticket pass, credit each venue of the second set of venues based on (1) how many venues are in the second set of venues, (2) an amount of money paid by the customer for the electronic ticket pass, and (3) individual admission prices to each of the venues in the second set of venues. In an alternative embodiment, the system includes a mobile device that is operated by the customer and that is configured to display a unique identifier associated with the electronic ticket pass and an input device located at each of the venues in the first set of venues, the input device configured to read the unique identifier associated with the electronic ticket pass and transmit the unique identifier to the module for validation.

In another aspect of the present invention, a method for managing electronic ticket passes includes providing an electronic ticket pass that facilitates entry by a customer to each venue of a first set of venues selected by the customer, tracking visits by the customer to venues of a second set of venues that is a subset of the first set of venues, and upon expiration of the electronic ticket pass, crediting each venue of the second set of venues based on (1) how many venues are in the second set of venues, (2) an amount of money paid by the customer for the electronic ticket pass, and (3) individual admission prices to each of the venues in the second set of venues.

In an alternative embodiment, crediting each venue of the second set of venues includes crediting a first venue in the second set of venues an amount of money determined at least in part as a first quantity that is the individual admission price to the first venue divided by the sum of the individual admission prices to each of the venues in the second set of venues times a second quantity that is a total price of the electronic ticket pass minus handling fees. The handling fees may include a handling fee due to an operator of an electronic ticket pass system that performs the method or to a vendor that sold the electronic ticket pass to the customer. The second set of venues may be a proper subset of the first set of venues.

In an alternative embodiment, the method provides an interface configured to facilitate customer selection of the first set of venues from a third set of venues that encompasses the first set of venues, wherein each of the venues in the first set of venues has an associated individual admission price. It then determines a price for the electronic ticket pass that is lower than the sum of the individual admission prices associated with each of the venues in the first set of venues. The method may also receive the customer selection of the first set of venues from a kiosk system operated by the customer or receive the customer selection of the first set of venues from a mobile device operated by the customer.

In an alternative embodiment, the method stores a unique ticket pass identifier in association with an indication of the customer and the first set of venues; receives a validation request that includes the unique ticket pass identifier read from the electronic ticket pass and an indication of a venue; in response to the validation request, determines whether the customer is permitted to enter the indicated venue, based at least in part on whether the received identifier matches the stored unique ticket pass identifier and whether the indicated venue is one of the venues in the first set of venues; and transmits an indication of whether the customer is permitted to enter the indicated venue. The method may also cause information about the electronic ticket pass to be printed by a printer, stored and/or displayed on a mobile device of the customer. In the latter case, the method further includes transmitting a unique identifier associated with the electronic ticket pass to the mobile device and causing the unique identifier to be displayed on the mobile device via a barcode or a QR code.

In yet an alternative embodiment, providing an electronic ticket pass includes providing a card that includes a machine-readable data carrier that encodes information about the electronic ticket pass. In another embodiment, the machine-readable data carrier is at least one of a barcode, a QR code, an RFID chip, and/or a magnetic strip.

In an alternative embodiment, tracking visits by the customer to venues of a second set of venues includes receiving an indication that the electronic ticket pass has been read by a device located at one of the venues in the first set of venues and storing an indication of the one venue as part of the second set of venues.

### BRIEF DESCRIPTION OF THE DRAWINGS

Preferred and alternative examples of the present invention are described in detail below with reference to the following drawings:

FIG. 1 is a block diagram illustrating an electronic ticket pass environment according to an example embodiment;

FIG. 2 is a block diagram illustrating electronic ticket pass validation, tracking, and venue crediting according to an example embodiment;

FIG. 3.1-3.4 are example flow diagrams of electronic ticket pass management processes performed by example embodiments; and

FIG. 4 is an example block diagram of an example computing system for implementing an electronic ticket pass system according to an example embodiment.

### DETAILED DESCRIPTION OF THE PREFERRED EMBODIMENT

The described techniques relate to methods and systems for managing electronic ticket passes. An electronic ticket pass (or “ticket pass”) is maintained in an electronic format and allows a purchaser (e.g., user, customer, tourist, visitor) to access venues through a variety of physical means beyond a standard ticket book. In some embodiments, the purchaser will receive, from a Point of Sale (“POS”) kiosk at the time of purchase, a magnetic card that contains the information about the ticket pass. In another implementation, the purchaser is sent an electronic ticket pass to their mobile device (e.g., mobile phone, smart phone, tablet computer). In a third implementation, the purchaser can print out a hardcopy of the ticket pass on their computer printer.

In preferred embodiments, an input device (e.g., a scanner, a magnetic strip reader) at the venue receives information from the card, smart phone, or hardcopy of the ticket pass. The received information may be unique identifier that is associated with the ticket pass and/or the customer. The input device then transmits that received information to a network-accessible system and receives an acknowledgement that the individual in possession of the ticket pass is allowed or denied access to the venue.

Certain embodiments implement at least some of the described techniques in an Electronic Ticket Pass System (“ETPS”) that is configured to manage the distribution, use, validation, and allocation of moneys related to electronic ticket passes. The ETPS and other techniques described herein address the above-listed problems with prior approaches. In particular, the ETPS leverages improvements in technology to provide a system that is more beneficial to tourists and venues. The ETPS addresses the weaknesses of the ticket book system while still providing a simple means of entering venues.

In certain embodiments, the ETPS provides at least some of the following benefits. First, by linking the tourist with the ticket pass, any lost or stolen passes can quickly be voided and new ones issued. Second, venues are not required to purchase any ticket books. Sales of the electronic ticket pass are accounted for in the ticket pass system at the time of the sale and the venue is debited the amount of the sale. Third, ticket use is also accounted for electronically at the time of use. When a tourist enters a venue, the record of its use is sent to the ticket pass system and the venue is credited with the use of the ticket. Fourth, because no physical ticket book ever exists, it is much easier to create ticket passes that are specific to a tourist's interests and needs. The tourist will have a much wider range of choices.

### System Overview

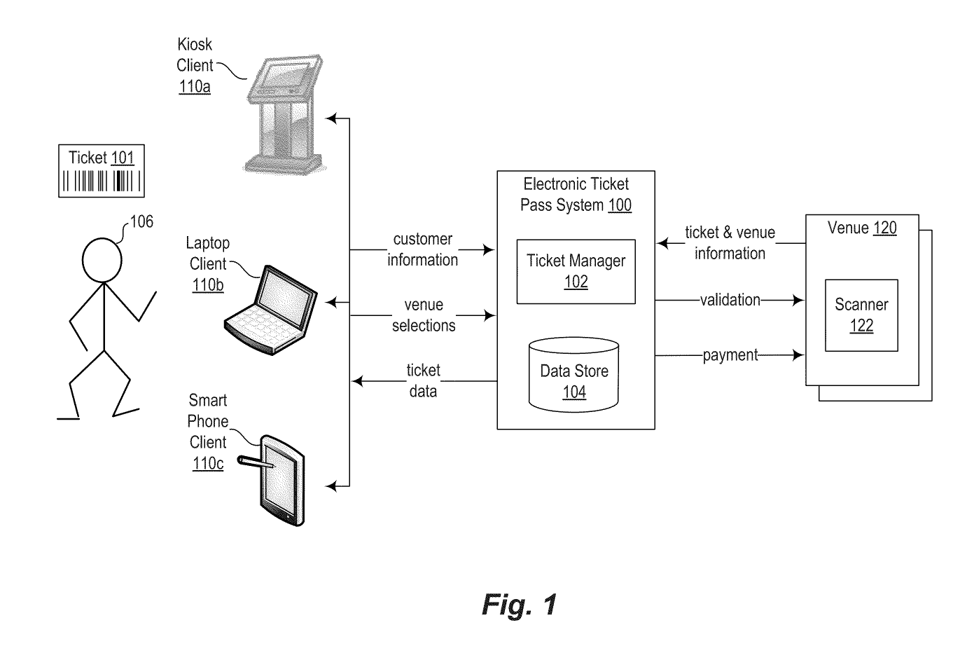

FIG. 1 is a block diagram illustrating an electronic ticket pass environment according to an example embodiment. In particular, FIG. 1 illustrates an example Electronic Ticket Pass System (“ETPS”) 100 interacting with a customer 106 via one or more client devices 110 to provide an electronic ticket pass 101. The ETPS 100 is also interacting with venues 120.

The ETPS 100 includes a ticket manager 102 and a data store 104. The ticket manager 102 includes logic (e.g., instructions) for managing the distribution (e.g., sale, transmission), use, validation, and accounting of electronic ticket passes. The data store 104 records information about customers, electronic ticket passes (and use thereof), venues, and the like.

In the illustrated example, the customer 106 obtains an electronic ticket pass 101 by using one or more of the client devices 110. The kiosk client 110 is a kiosk-based computing system located in a public location, such as an airport, store, restaurant, hotel, or the like. The laptop client 110b is a personal computer of the customer 106. The smart phone client 110c is a mobile device of the customer 106.

The customer 106 may use any of the client devices 110 to obtain an electronic ticket pass. In particular, a client device 110 may present an interface that is configured to receive customer information, venue selections (from a “menu” of different available venues), and payment information (e.g., a credit card number). This information is transmitted by the client device 110 to the ETPS 100. In response, the ETPS 100 generates a unique identifier and records it in association with the received information in the data store 104. Then, the ETPS 100 transmits ticket data back to the client device 110. The transmitted ticket data may include or indicate the selected venues, expiration date, price, the unique identifier, and the like. In some embodiments, the ticket data may be encoded in a machine-readable form, such as a barcode, QR code, magnetic medium, RFID tag, or the like.

In one embodiment, the client device 110 prints the received ticket data (or some representation thereof). For example, the kiosk client 110a may include a printer that is configured to print or encode a ticket 101 that is then provided to the customer 106. Similarly, the customer 106 may use a printer attached to the laptop client 110b to print out the ticket 101.

In another embodiment, the client device 110 stores the received ticket data for later display. For example, the smart phone client 110c may store the received ticket data (e.g., a barcode or QR code) so that the customer 106 can display it to obtain entry to a venue. In such an embodiment, there is no separate piece of paper or card that need be carried by the customer 106.

Once the customer 106 has received the electronic ticket pass, he may use it to obtain entry to one or more of the venues 120. Each of the participating venues 120 includes a scanner 122 or other input device configured to read information from the customer's electronic ticket pass, such as its unique identifier. The venue then transmits a validation request to the ETPS 100. The validation request includes information from the electronic ticket pass, such as the unique identifier, along with an identifier of the venue. In response, the ETPS 100 determines whether the unique identifier is associated with the venue in the data store 104, possibly along with other checks, such as whether the ticket pass is still valid, unexpired, and the like. This determination is transmitted back to the venue 120, so that the customer's entry can be allowed or disallowed. The ETPS 100 also records the fact that the customer has used the ticket pass to gain entry to the venue 120.

Once the electronic ticket pass expires, the ETPS 100 distributes funds (payments) to the venues visited using the electronic ticket pass. In one embodiment, the funds are distributed based on multiple factors, including the individual admission prices to the visited venues (e.g., the non-discounted price in absence of a ticket pass), handling fees, and the total price of the electronic ticket pass, as discussed further below.

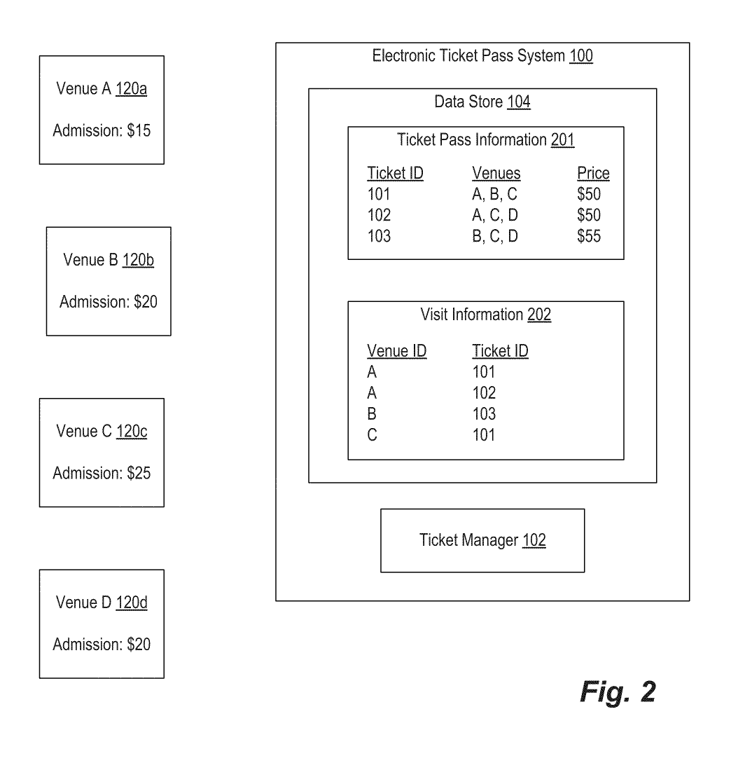

FIG. 2 is a block diagram illustrating electronic ticket pass validation, tracking, and venue crediting according to an example embodiment. In particular, FIG. 2 depicts example information stored and collected by the ETPS 100 with respect to tickets and venues 120. Each venue 120a-120d has a corresponding individual admission price, which is the price a visitor would have to pay if they did not use an electronic ticket pass. For example, the admission price for venue A (120a) is $15.

In the illustrated example, the data store 104 of the ETPS 100 includes ticket pass information 201 and visit information 202. Ticket pass information 201 records information about ticket passes provided by the ETPS 100. In particular, ticket pass information 201 associates a unique ticket identifier (“Ticket ID”) with one or more venues and a corresponding ticket price. Note that in each case, the ticket price is lower than the sum of the individual venue prices. For example, for ticket ID 101, which entitles access to venues A, B, and C, the ticket price is $50 rather than the $60 that would obtain from paying the individual admission prices for those venues.

Visit information 202 tracks which venues have been accessed by each ticket pass. For example, the illustrated information 202 indicates that ticket ID 101 has been used to visit venues A and C; ticket ID 102 has been used to visit venue A; and ticket ID 103 has been used to visit venue B.

Information 201 and 202 may be used by the ticket manager 102 during validation. For example, ticket information 201 can be referenced by the manager 102 to determine whether a ticket pass holder is entitled to access a given venue. In addition, visit information 202 can be used to limit a customer to a single visit to each venue.

The ticket manager 102 also uses information 201 and 202 to allocate funds to venues for use of electronic ticket passes. In one embodiment, when a customer purchases a ticket pass from a vendor, the ticket pass server debits the vendor's account for the cost of the ticket pass minus a handling fee. When a customer uses a ticket pass to enter a venue, the system tracks the use of the ticket for the venue. In FIG. 2, this is illustrated as adding a record to visit information 202.

The actual credit due to the venue is not actually calculated until after the ticket pass has expired. At that point, the following formula may be used to calculate the credit:

[symbol]

Where Cᵢ represents the portion of income to one of the vendors (vendor i) visited by the customer; tᵢ represents the cost of the ticket to the customer if purchased individually; m represents the total number of sites visited by the customer; T represents the total cost of the ticket pass; F_{agent} represents the handling fee due to the operator of the ETPS 100; and F_{vendor} represents the handling fee due to the vendor that sells the ticket pass.

In the example of FIG. 2, when ticket pass ID 101 expires, the credit due to venue A (120a) would be calculated as follows. Ticket pass ID 101 was used to access venues A and C (and not B). In addition, assume a $2 handing fee due to the vendor of the ticket pass and $3 handling fee due to the operator of the ETPS 100. Thus, venue A's credit would be $15/($15+$20)×($50−$2−$3), or about $19.29. Note that venue A actually received an amount of money that is greater than its individual admission price of $15, because the user never visited venue C. If the user had visited each of venues A, B, and C, then venue A's credit would be $15/($15+$ 20+$25)×($50−$2−$3), or $11.25.

Using the above formula allows the income generated by the ticket pass sales to be fairly distributed to all venues. Those venues with more expensive tickets will receive more income from the sale when their sites are visited. A venue that is not visited will not obtain any income. Because this formula relies on knowing which sites were visited with a particular ticket pass, the actual accounting of a ticket pass is performed after the ticket pass has expired.

In the following, various additional details related to electronic ticket passes and embodiments of an ETPS are provided. In any given embodiment, one or more of the below-described aspects may not be present.

In one embodiment, the ETPS is connected to a database and is accessible via the Internet to vendors and customers. The ETPS is the access point for the ticket vendors selling the electronic ticket passes and the ticket takers who accept the ticket passes. At each vendor location, the ticket sellers have a system for interfacing with the ETPS. In another embodiment, the ticket seller would have a dedicated ticket pass terminal. The ticket pass terminal provides the interface into which information about ticket pass order is entered. That information is sent to the ETPS which stores the information about the order and generates a unique identifier of the ticket pass that is returned to the ticket terminal. The terminal then creates a scannable card such as one with a magnetic strip or with a printed QR code. The card may be subsequently scanned at any of the associated venues' entry points to allow access to the customer.

In another embodiment, each of the venues or vendors includes an automated kiosk that allows the customer to pick and choose the options they want for their ticket pass. When the customer is ready to purchase the ticket pass, they swipe their credit card into the kiosk. The ticket information along with the credit card information is sent along to the ETPS. The ETPS handles credit card authorization and, once the card is approved, a unique ticket pass identifier is generated and returned to the kiosk. The kiosk then creates the physical scannable card.

In another embodiment, a Web interface is provided so that a customer can browse to from their home computer or smart phone. This approach is similar as using a kiosk. The customer chooses the options they want on their ticket pass, and submits this information along with their credit card to the Web interface. The Web interface forwards this information on to the ETPS which authorizes the credit card as before and returns the unique ticket pass identifier to the Web interface. At this point in the process, the customer can choose to have the ticket pass delivered to their smart phone as an SMS message or printed from their home computer. In either case, a QR code (or other machine-readable identifier) is generated containing the unique ticket pass identifier. If it is to be sent to a smart phone, it is forwarded there, otherwise a printable page is created with the ticket pass containing the QR Code and the customer is asked to print the page for their use.

Entering a venue is similar in all embodiments of this invention. A customer can enter through a ticket booth attended by a ticket attendant, or the customer can enter through an automated ticket gate. In either case, the customer produces the ticket pass to be validated by a ticket validation terminal. The form of the ticket pass can be any of the previously mentioned physical manifestations. A scanner or other input device attached to the ticket validation terminal is used to fetch the ticket pass information from the pass. This information, along with the venue information, is packaged by the system software into a validation request that is sent to the ETPS.

The ETPS receives the validation request and determines if the customer is allowed to enter the venue. Validation consists of several steps by the ETPS. Validation includes, but is not limited to, determining if the ticket pass has been reported as lost or stolen and determining if the ticket pass has expired. The last step in the validation process is to determine if the ticket pass is valid at the specified venue. If any of the validation steps fail, then a validation response is sent to the ticket validation terminal declining access to the venue. If all validation steps pass, then the ticket pass server sends a validation response to the ticket validation terminal allowing the customer access to the venue. The ETPS records that the customer entered the venue. At this point, if the customer is entering through an automated ticket gate, the gate would open. Otherwise, the ticket attendant would allow the customer to pass through the ticket gate.

The system at the entry gate can be very simple, allowing a single customer to enter per ticket pass, or can be more complex, depending on what features are added to the ticket pass itself. One embodiment allows a family to purchase a single ticket pass for the entire family, including adults, senior citizens and children. In this case, the ticket validation terminal would have the ability to determine the number of entrants allowed either by counting the number of people entering through the gate or by allowing the card to be scanned multiple times by the ticket validation terminal. Alternatively, access in these situations could be controlled by the ticket attendant.

### Example Processes

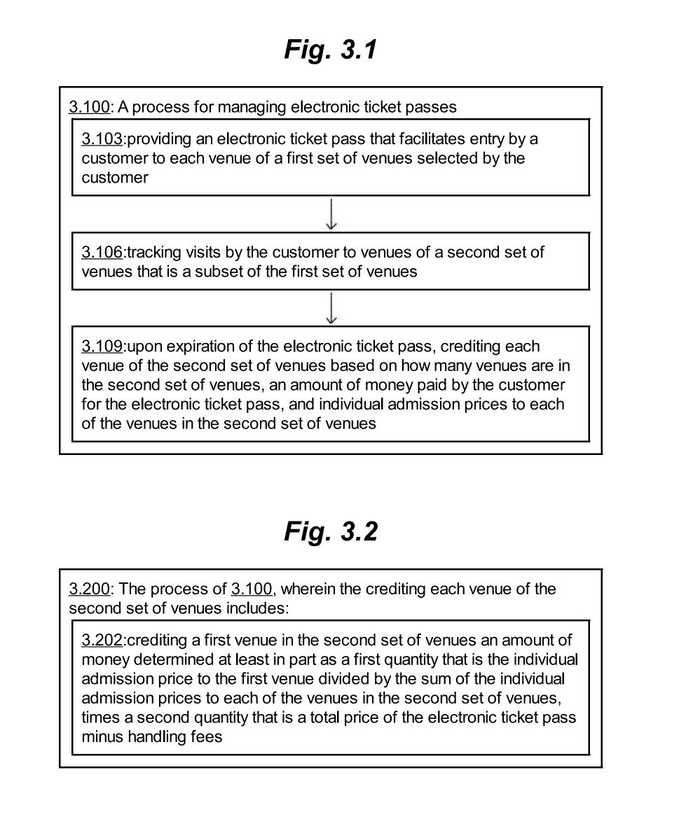

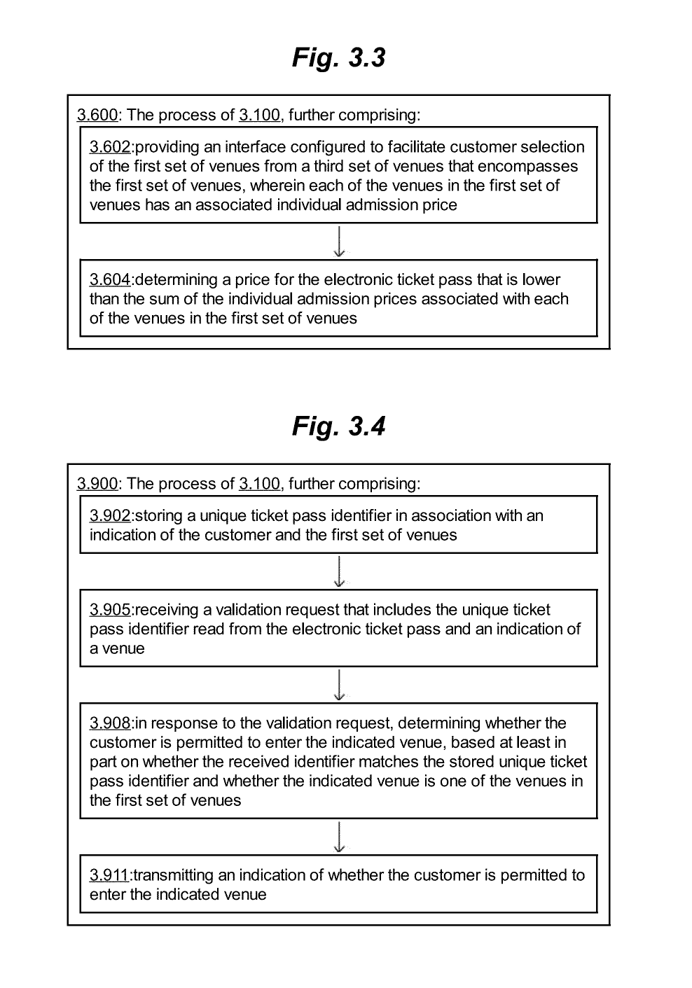

FIG. 3.1-3.4 are example flow diagrams of electronic ticket pass management processes performed by example embodiments.

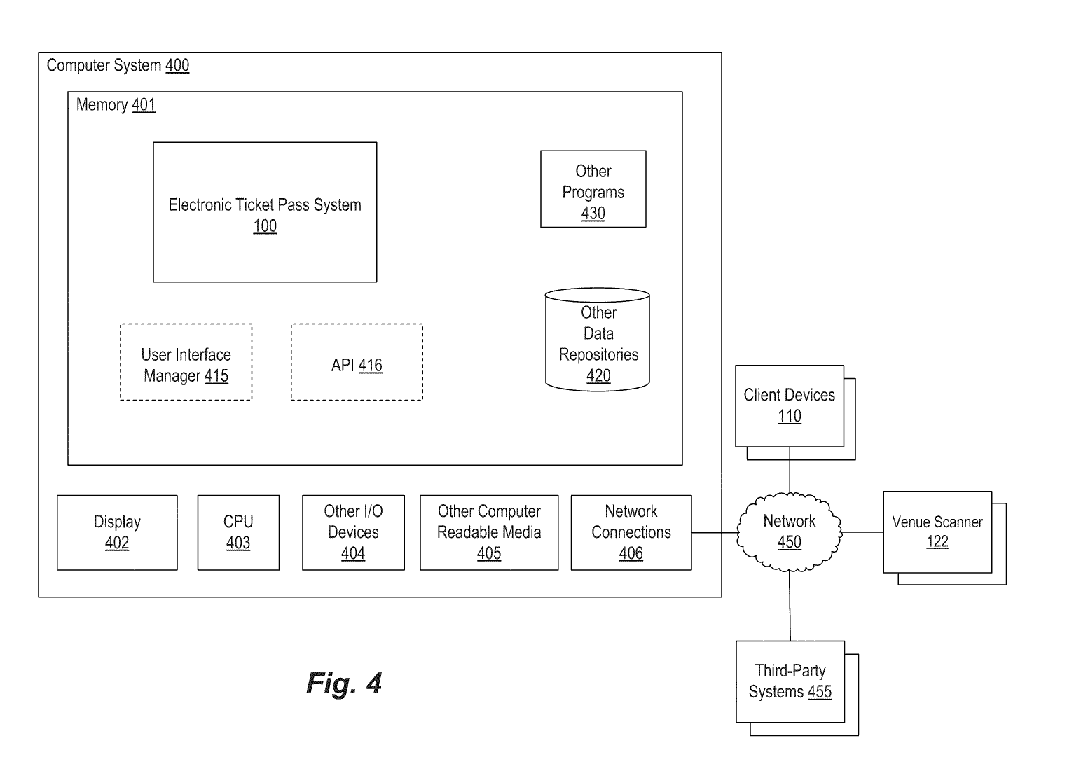

FIG. 3.1 is an example flow diagram of example logic for managing electronic ticket passes. The illustrated logic in this and the following flow diagrams may be performed by, for example, one or more components of the ETPS 100 described with respect to FIGS. 1 and 2, above. The ETPS 100 may be implemented as discussed further with respect to FIG. 4, below. More particularly, FIG. 3.1 illustrates a process 3.100 that includes operations performed by or at the following block(s).

At block 3.103, the process performs providing an electronic ticket pass that facilitates entry by a customer to each venue of a first set of venues selected by the customer. In some embodiments, providing the electronic ticket pass includes providing a card that includes a machine-readable data carrier (e.g., a barcode or magnetic strip) that encodes information about the electronic ticket pass, such as a unique identifier, customer identity, or the like. In other embodiments, providing the electronic ticket pass includes transmitting information about the electronic ticket pass to a device of the user, so that the user can display or print the electronic ticket pass via the device. For example, the process may transmit a barcode or QR code for display on the customer's smart phone. As another example, the process may transmit a barcode and related information that can be printed by the customer's personal computer. Providing the electronic ticket pass may also include receiving a selection of the venues in the first set of venues from the customer, selected from a possibly larger, encompassing set of venues. In this manner, the process can provide a customized or tailored electronic ticket pass that enables entry to just those venues that are of interest to the customer.

At block 3.106, the process performs tracking visits by the customer to venues of a second set of venues that is a subset of the first set of venues. Tracking visits by the customer may include recording the fact that the customer has visited a particular venue. In addition, tracking visits may include validating the electronic ticket pass with respect to a particular venue, in order to determine whether the customer is allowed to enter the venue. In some embodiments, a unique identifier is associated with the electronic ticket pass, the customer, and the venues selected by the customer. This unique identifier, when received by the process from an input device or scanner at a venue, can be used to determine whether the customer is entitled to access the venue.

At block 3.109, the process performs upon expiration of the electronic ticket pass, crediting each venue of the second set of venues based on how many venues are in the second set of venues, an amount of money paid by the customer for the electronic ticket pass, and individual admission prices to each of the venues in the second set of venues. In some embodiments, each venue visited by the customer is credited an amount of money that is based on multiple factors, including the total amount paid for the ticket pass, the individual admission prices to the venues, handling fees, and the like. Crediting each venue may also include initiating a funds transfer to an account associated with a venue, crediting an account associated with a venue, preparing a check payment, or the like.

FIG. 3.2 is an example flow diagram of example logic illustrating an example embodiment of process 3.100 of FIG. 3.1. More particularly, FIG. 3.2 illustrates a process 3.200 that includes the process 3.100, wherein the crediting each venue of the second set of venues includes operations performed by or at one or more of the following block(s).

At block 3.202, the process performs crediting a first venue in the second set of venues an amount of money determined at least in part as a first quantity that is the individual admission price to the first venue divided by the sum of the individual admission prices to each of the venues in the second set of venues, times a second quantity that is a total price of the electronic ticket pass minus handling fees. By allocating money in this manner, the process distributes funds fairly amongst the venues that have been visited by the user. Venues not visited do not receive any distribution. In addition, the share that goes to each visited venue is proportional to that venue's contribution to the total price of the ticket pass, such that a more expensive venue will receive a relatively larger share of the overall ticket pass price.

FIG. 3.3 is an example flow diagram of example logic illustrating an example embodiment of process 3.100 of FIG. 3.1. More particularly, FIG. 3.3 illustrates a process 3.600 that includes the process 3.100, and which further includes operations performed by or at the following blocks(s).

At block 3.602, the process performs providing an interface configured to facilitate customer selection of the first set of venues from a third set of venues that encompasses the first set of venues, wherein each of the venues in the first set of venues has an associated individual admission price. In some embodiments, the process provides a user interface that can be accessed by the customer to select venues of his choice. The user interface may be provided as a Web page by a server for display on a Web browser. In other embodiments, the user interface may be a mobile app executing on a smart phone or other mobile device of the customer.

At block 3.604, the process performs determining a price for the electronic ticket pass that is lower than the sum of the individual admission prices associated with each of the venues in the first set of venues. Once the customer has selected his preferred venues, the process calculates a total price for the electronic ticket pass. The price may be calculated by summing the individual prices of the various venues, and then taking a discount (e.g., 10%, 20%) off of the sum. The ticket pass may be discounted in other ways, such as by an amount based on how many venues are selected (e.g., 5 dollars off for two venues, 10 dollars off for three venues).

FIG. 3.4 is an example flow diagram of example logic illustrating an example embodiment of process 3.100 of FIG. 3.1. More particularly, FIG. 3.4 illustrates a process 3.900 that includes the process 3.100, and which further includes operations performed by or at the following blocks(s).

At block 3.902, the process performs storing a unique ticket pass identifier in association with an indication of the customer and the first set of venues. The process may generate and store a unique identifier in association with the customer and the venues selected by the customer. This association may be stored in a database by the process for later access. In addition, the unique identifier may be encoded on a card or other medium that is used by the customer to gain entry into the selected venues.

At block 3.905, the process performs receiving a validation request that includes the unique ticket pass identifier read from the electronic ticket pass and an indication of a venue. When the customer visits the venue, the venue will obtain the unique identifier from the ticket pass (e.g., by scanning a card or image on the customer's mobile phone) and transmit the identifier to the process for validation.

At block 3.908, the process performs in response to the validation request, determining whether the customer is permitted to enter the indicated venue, based at least in part on whether the received identifier matches the stored unique ticket pass identifier and whether the indicated venue is one of the venues in the first set of venues. The process compares the received identifier with the stored unique identifier to determine a match. In addition, the process will determine whether the received identifier is associated with the particular venue being visited by the customer. The process may perform further checks at this point, such as determining whether the pass is expired.

At block 3.911, the process performs transmitting an indication of whether the customer is permitted to enter the indicated venue. The result of the above determination is transmitted back to the venue, where it can be used by a human or machine (e.g., gate, turnstile) to allow or disallow entry into the venue.

### Example Computing System Implementation

FIG. 4 is an example block diagram of an example computing system for implementing an electronic ticket pass system according to an example embodiment. In particular, FIG. 4 shows a computing system 400 that may be utilized to implement an ETPS 100.

Note that one or more general purpose or special purpose computing systems/devices may be used to implement the ETPS 100. In addition, the computing system 400 may comprise one or more distinct computing systems/devices and may span distributed locations. Furthermore, each block shown may represent one or more such blocks as appropriate to a specific embodiment or may be combined with other blocks. Also, the ETPS 100 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406. The ETPS 100 is shown residing in memory 401. In other embodiments, some portion of the contents, some or all of the components of the ETPS 100 may be stored on and/or transmitted over the other computer-readable media 405. The components of the ETPS 100 preferably execute on one or more CPUs 403 and implement techniques described herein. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 4 may not be present in any specific implementation. For example, some embodiments may not provide other computer readable media 405 or a display 402.

The ETPS 100 interacts via the network 450 with client devices 110, venue scanners 122, and third-party systems/applications 455. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/applications 455 may include any systems that provide data to, or utilize data from, the ETPS 100, including Web browsers/servers, payment processors, banks, travel information systems, and the like.

The ETPS 100 is shown executing in the memory 401 of the computing system 400. Also included in the memory are a user interface manager 415 and an application program interface (“API”) 416. The user interface manager 415 and the API 416 are drawn in dashed lines to indicate that in other embodiments, functions performed by one or more of these components may be performed externally to the ETPS 100.

The UI manager 415 provides a view and a controller that facilitate user interaction with the ETPS 100 and its various components. For example, the UI manager 415 may provide interactive access to the ETPS 100, such that users can configure the operation of the ETPS 100, such as by providing the ETPS 100 with information about available venues, or the like. In some embodiments, access to the functionality of the UI manager 415 may be provided via a Web server, possibly executing as one of the other programs 430. In such embodiments, a user operating a Web browser executing on one of the client devices 110 and/or third-party systems 455 can interact with the ETPS 100 via the UI manager 415.

The API 416 provides programmatic access to one or more functions of the ETPS 100. For example, the API 416 may provide a programmatic interface to one or more functions of the ETPS 100 that may be invoked by one of the other programs 430 or some other module. In this manner, the API 416 facilitates the development of third-party software, such as user interfaces, plug-ins, adapters (e.g., for integrating functions of the ETPS 100 into client systems or devices), and the like.

In addition, the API 416 may be in at least some embodiments invoked or otherwise accessed via remote entities, such as code executing on one of the client devices 110 and/or one of the third-party systems/applications 455, to access various functions of the ETPS 100. For example, a travel information system (e.g., booking system) can obtain data about available ticket pass venues from the ETPS 100 via the API 416. The API 416 may also be configured to provide interface code modules that can be integrated into the client devices 110 and/or third-party applications 455 and that are configured to interact with the ETPS 100 to make at least some of the described functionality available within the context of other applications (e.g., mobile apps).

In an example embodiment, components/modules of the ETPS 100 are implemented using standard programming techniques. For example, the ETPS 100 may be implemented as a “native” executable running on the CPU 403, along with one or more static or dynamic libraries. In other embodiments, the ETPS 100 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the ETPS 100, such as in the data store 420 (or 104), can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 420 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the ETPS 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method for managing electronic ticket passes, the method comprising:
providing an electronic ticket pass that facilitates entry by a customer to each venue of a first set of venues selected by the customer;
tracking visits by the customer to venues of a second set of venues that is a subset of the first set of venues; and
upon expiration of the electronic ticket pass, crediting each venue of the second set of venues based on how many venues are in the second set of venues, an amount of money paid by the customer for the electronic ticket pass, and individual admission prices to each of the venues in the second set of venues.

2. The method of claim 1, wherein the crediting each venue of the second set of venues includes: crediting a first venue in the second set of venues an amount of money determined at least in part as a first quantity that is the individual admission price to the first venue divided by the sum of the individual admission prices to each of the venues in the second set of venues, times a second quantity that is a total price of the electronic ticket pass minus handling fees.

3. The method of claim 2, wherein the handling fees include a handling fee due to an operator of an electronic ticket pass system that performs the method.

4. The method of claim 2, wherein the handling fees include a handling fee due to a vendor that sold the electronic ticket pass to the customer.

5. The method of claim 1, wherein the second set of venues is a proper subset of the first set of venues.

6. The method of claim 1, further comprising:
providing an interface configured to facilitate customer selection of the first set of venues from a third set of venues that encompasses the first set of venues, wherein each of the venues in the first set of venues has an associated individual admission price; and
determining a price for the electronic ticket pass that is lower than the sum of the individual admission prices associated with each of the venues in the first set of venues.

7. The method of claim 6, further comprising: receiving the customer selection of the first set of venues from a kiosk system operated by the customer.

8. The method of claim 6, further comprising: receiving the customer selection of the first set of venues from a mobile device operated by the customer.

9. The method of claim 1, further comprising:
storing a unique ticket pass identifier in association with an indication of the customer and the first set of venues;
receiving a validation request that includes the unique ticket pass identifier read from the electronic ticket pass and an indication of a venue;
in response to the validation request, determining whether the customer is permitted to enter the indicated venue, based at least in part on whether the received identifier matches the stored unique ticket pass identifier and whether the indicated venue is one of the venues in the first set of venues; and
transmitting an indication of whether the customer is permitted to enter the indicated venue.

10. The method of claim 1, wherein the providing an electronic ticket pass includes: causing information about the electronic ticket pass to be printed by a printer.

11. The method of claim 1, wherein the providing an electronic ticket pass includes: causing information about the electronic ticket pass to be stored and displayed on a mobile device of the customer.

12. The method of claim 11, wherein the causing information about the electronic ticket pass to be stored and displayed on a mobile device of the customer includes:
transmitting a unique identifier associated with the electronic ticket pass to the mobile device; and
and causing the unique identifier to be displayed on the mobile device via a barcode or a QR code.

13. The method of claim 1, wherein the providing an electronic ticket pass includes: providing a card that includes a machine-readable data carrier that encodes information about the electronic ticket pass.

14. The method of claim 13, wherein the machine-readable data carrier is at least one of a barcode, a QR code, an RFID chip, and/or a magnetic strip.

15. The method of claim 1, wherein the tracking visits by the customer to venues of a second set of venues includes:
receiving an indication that the electronic ticket pass has been read by a device located at one of the venues in the first set of venues; and
storing an indication of the one venue as part of the second set of venues.

16. A non-transitory computer-readable medium including contents that are configured, when executed, to cause a computing system to perform a method for managing electronic ticket passes, the method comprising:
providing an electronic ticket pass that facilitates entry by a customer to each venue of a first set of venues;
tracking visits by the customer to venues of a second set of venues that is a subset of the first set of venues; and
upon expiration of the electronic ticket pass, crediting each venue of the second set of venues based on how many venues are in the second set of venues, an amount of money paid by the customer for the electronic ticket pass, and individual admission prices to each of the venues in the second set of venues.

17. The computer-readable medium of claim 16, wherein the method further comprises:
storing a unique ticket pass identifier in association with an indication of the customer and the first set of venues;
receiving a validation request that includes the unique ticket pass identifier read from the electronic ticket pass and an indication of a venue;
in response to the validation request, determining whether the customer is permitted to enter the indicated venue, based at least in part on whether the received identifier matches the stored unique ticket pass identifier and whether the indicated venue is one of the venues in the first set of venues;
transmitting an indication of whether the customer is permitted to enter the indicated venue; and
crediting the indicated venue.

18. The computer-readable medium of claim 16, wherein the contents include instructions that are stored in a memory of the computing system and that cause the computing system to perform the method when executed by a processor of the computing system.

19. A system for managing electronic ticket passes, the system comprising:
a processor;
a memory; and
a module that is stored in the memory and that is configured, when executed by the processor, to:
provide an electronic ticket pass that facilitates entry by a customer to each venue of a first set of venues;
track visits by the customer to venues of a second set of venues that is a subset of the first set of venues; and
upon expiration of the electronic ticket pass, credit each venue of the second set of venues based on how many venues are in the second set of venues, an amount of money paid by the customer for the electronic ticket pass, and individual admission prices to each of the venues in the second set of venues.

20. The system of claim 19, further comprising:
a mobile device that is operated by the customer and that is configured to display a unique identifier associated with the electronic ticket pass; and
an input device located at each of the venues in the first set of venues, the input device configured to read the unique identifier associated with the electronic ticket pass, and transmit the unique identifier to the module for validation.
